(19) United States
(12) Patent Application Publication
(10) Pub. No.: US 2009/0236443 A1
(43) Pub. Date: Sep. 24, 2009

(54) Apparatus for Dispensing Fluid

(75) Inventors: Paul Hoyes, Sheffield (GB); Neil McGowan, West Yorkshire (GB)

Correspondence Address: HARNESS, DICKEY & PIERCE, P.L.C., P.O. BOX 828, BLOOMFIELD HILLS, MI, 48303, US

(73) Assignee: KILLGERM GROUP LIMITED, Ossett, West Yorkshire (GB)

(21) Appl. No.: 12/084,440

(22) PCT Filed: Oct. 25, 2006
(86) PCT No.: PCT/GB2006/003964

§ 371 Date: May 29, 2009

(30) Foreign Application Priority Data
Nov. 2, 2005 (GB) 0522332.6

(51) Int. Cl. B05B 15/00

(52) U.S. Cl. 239/274; 239/302

(57) ABSTRACT

An apparatus (11) for dispensing fluid from a fluid container (30). The apparatus comprises a fluid chamber (12) with an outlet wall (15) containing a fluid outlet (14) and an inlet wall (13) containing a fluid inlet (16). A nozzle (17) extends from the inlet. A cradle (21) is fixed to the inlet wall for seating the fluid container. The cradle is manipulable in a manner such as to move the fluid container to selected positions The selected positions include one or more dismount positions in which the fluid container is dismountable and a retained position in which the fluid container is retained in sealed engagement with the nozzle.

The present invention relates to an apparatus for dispensing fluid from a fluid container.

Ultra low volume (ULV) devices are commonly use for dispensing fine sprays from a liquid container in a number of different circumstances. For example, such devices may be used for dispensing insecticides, biocides, disinfectants or deodorisers and may be used in domestic, industrial or sterile environments (eg hospitals). Once the liquid from the container has been exhausted, it may be replenished by removing and then replacing or refilling the container.

One conventional ULV device of this type incorporates a dispensing chamber to which is fed liquid from a liquid container through a spray nozzle. The liquid container is mounted in a position adjacent to an exterior wall of the dispensing chamber. The open head end of the liquid container is urged into operative engagement with a compressible seal of the spray nozzle by a wall-mounted flat spring in contact with the closed basal end. This arrangement is unreliable. The flat spring is prone to breakage under the significant weight of the liquid container. Moreover, the weight of the liquid container acting against the bias of the spring can lead to periodic or total loss of seal integrity (which in turn may lead to contamination of the spray or inconsistent delivery of the spray). Furthermore with prolonged use the spring may lose its integrity or be vulnerable to wear which can again compromise the seal.

The present invention seeks to improve the reliability of an apparatus for dispensing liquid by using a cradle to retain the liquid container in sealing engagement with the inlet nozzle.

Thus viewed from one aspect the present invention provides an apparatus for dispensing fluid from a fluid container comprising:
a fluid chamber with an outlet wall containing a fluid outlet and an inlet wall containing a fluid inlet;
a nozzle extending from or connected to the inlet;
a cradle fixed to the inlet wall for seating the fluid container, wherein the cradle is manipulable in a manner such as to move the fluid container to selected positions including one or more dismount positions in which the fluid container is dismountable and a retained position in which the fluid container is retained in sealed engagement with the nozzle.

The cradle acts as a rigid retaining means which advantageously serves to maintain the integrity of the seal when the fluid container is in the retained position.

The cradle may be manipulable substantially linearly or in a curve (eg arcuately) such as to move the fluid container to the selected positions. The fluid container may move substantially linearly (eg substantially linearly upwardly). In a preferred embodiment, the cradle is pivotal in a manner such as to move the fluid container to the selected positions.

Preferably in a plurality of the selected positions including the retained position the fluid container is in sealed engagement with the nozzle. For this purpose, the nozzle may contain a resilient (eg compressible) seal against which the fluid container may be in sealed engagement in the plurality of the selected positions including the retained position.

Preferably the one or more dismount positions include the position of the fluid container when the cradle is at-rest. For example, the sole dismount position may be the position of the fluid container when the cradle is at-rest.

In a preferred embodiment, the cradle is manipulable (eg pivotal) in a manner whereby to progressively urge the fluid container into sealed engagement with the nozzle.

In a preferred embodiment, the cradle is restrainable when the fluid container is at the retained position. For example, the cradle may be self-restrained when the fluid container is at the retained position or may be restrained by a restraining fastener when the fluid container is at the retained position. Preferably the restraining fastener comprises a restraining latch selectively latchable with a restraining notch (or slot or groove). The restraining latch may be on the cradle and the restraining notch may be on the inlet wall or a fixed part of the cradle.

In a preferred embodiment in use, the cradle is manipulated into a position (other than the retained position) in which the fluid container is in sealed engagement with the nozzle, the restraining latch is manipulated into a configuration for latching and the cradle is released so that the restraining latch latches the restraining notch and restrains the fluid container in the retained position.

The fluid container in the retained position may be retained in juxtaposition (eg in intimate juxtaposition) to the inlet wall. The fluid container in the retained position may be substantially parallel to the inlet wall. The cradle when the fluid container is in the retained position may be in juxtaposition (eg in intimate juxtaposition) to the inlet wall.

The fluid container may be assisted to be seated on the cradle by selectively engageable male and female portions. This advantageously helps to withstand relative lateral movement of the fluid container and cradle and so helps to prevent the fluid container being is dislodged during manipulation. For example, the exterior base of the fluid container may be provided with a cut-away portion capable of substantially confining a prominent portion of the cradle. The cut-away portion may be an elongate trough with a substantially crescent cross-section and the prominent portion of the cradle may be an elongate substantially cylindrical shaft engageable with the cut-away portion.

In a preferred embodiment, the apparatus further comprises
a frame rigidly fixed to the inlet wall;
   and the cradle comprises:
a crank including an eccentric crankshaft for seating the fluid container, wherein the crank is pivotally mounted on the frame and is pivotal such that the crankshaft turns eccentrically to move the fluid container to the selected positions.

Preferably the crank further comprises: a crank handle (eg an elongate crank handle). The crank handle may be substantially linear.

The eccentric crankshaft is preferably substantially U-shaped. The substantially U-shaped crankshaft may be transversely elongate. For example, the substantially U-shaped crankshaft may include an elongate base (eg a cylindrical base) with upstanding legs (eg legs substantially perpendicular to the elongate base). The legs may extend into first and second lateral extensions which pivotally engage the frame. The first lateral extension may extend into (or be integral with) the crank handle.

In a preferred embodiment, the crank (eg the crank handle) comprises a restraining latch selectively engageable with a restraining notch. The restraining latch may be a transversely extending foot. The foot may be U-shaped. The restraining notch may be provided on the frame. The restraining notch may be inclined towards the nozzle (eg upwardly).

The substantially U-shaped crankshaft is preferably non-coplanar with the crank handle. Particularly preferably the crankshaft is out of the plane of the crank handle by an angle of 20° or more, particularly preferably an angle of 30° or more, more preferably an angle in the range 35-65° (eg about 45°).

Preferably the angle between the crankshaft and the inlet wall is greater than the angle between the crank handle and the inlet wall. For example, the angle between the crankshaft and the inlet wall is greater than the angle between the crank handle and the inlet wall by 20° or more, preferably 30° or more, more preferably 35-65° (eg about 45°).

In a preferred embodiment, when the fluid container is at the retained position the crank handle is in juxtaposition (eg in intimate juxtaposition) to the inlet wall. The crank may be pivotal away from the inlet wall. The at-rest position of the crank may be substantially perpendicular to the inlet wall.

The frame may comprise a pair of substantially parallel, spaced apart elongate frame parts. Preferably the frame parts are substantially L-shaped. This is advantageous in that the L-shaped frame parts can be fixed to the inlet wall with a spaced apart distance sufficient to confine the fluid container therebetween so as to provide further support to the fluid container in the retained position.

The outlet wall and inlet wall may be opposed. The nozzle may be downwardly dependent (eg downwardly dependent in a direction substantially parallel to the inlet wall).

The fluid container may be a bottle. The fluid container may contain a liquid. The liquid may be an insecticide, biocide, disinfectant or deodoriser. The apparatus may be may be used in domestic, industrial or sterile environments (eg hospitals).

The apparatus of the invention may be used for dispensing liquid in the form of a spray (eg an ultra low volume spray). The dispensation of liquid (eg spray) may be motor driven.

In a preferred embodiment, the apparatus is operable to dispense liquid in the form of an ultra low volume spray.

The present invention will now be described in a non-limitative sense with reference to the accompanying Figures in which:

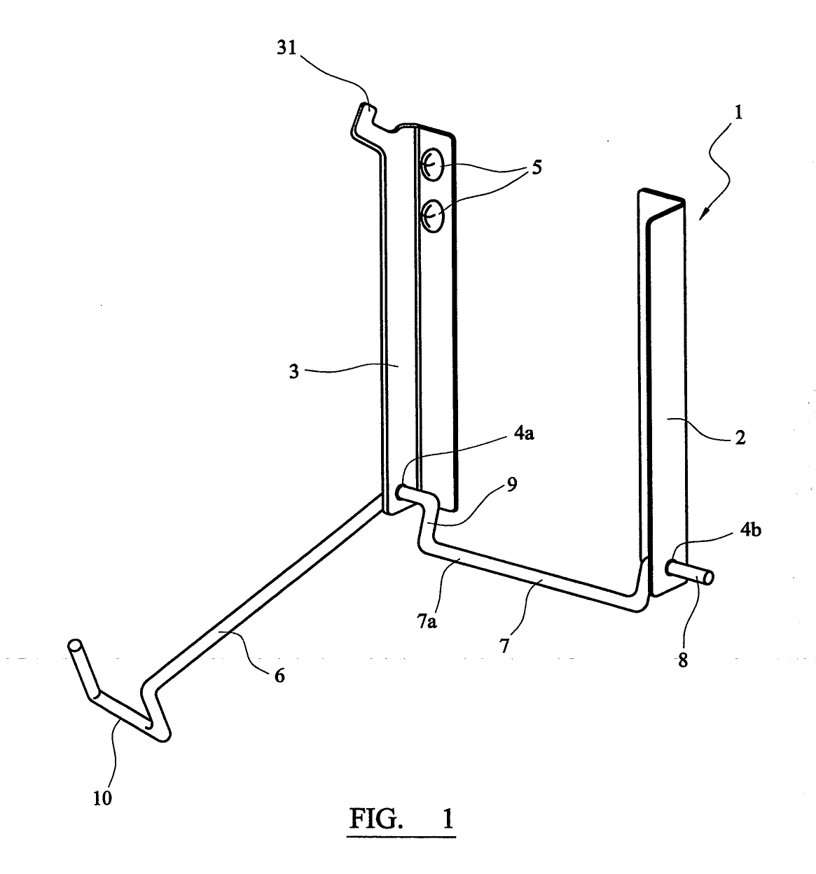

FIG. 1 is an isolated view of a crank of an embodiment of the apparatus of the invention; and

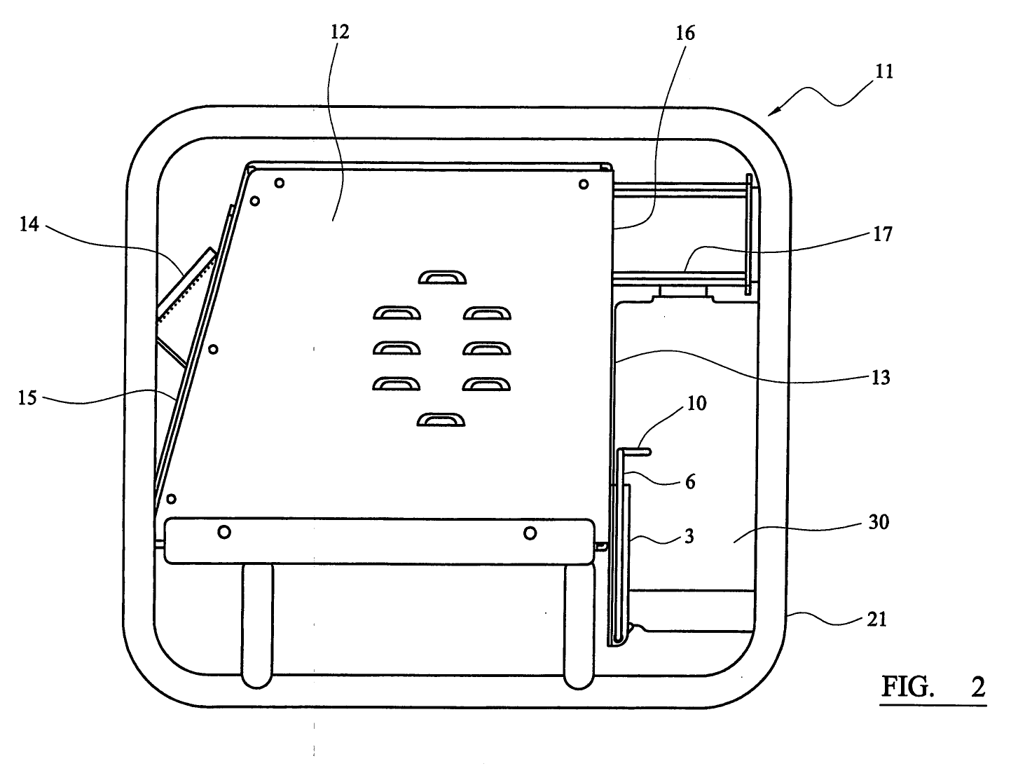

FIG. 2 illustrates an embodiment of the apparatus of the invention.

Shown in isolated view in FIG. 1 in the at-rest configuration is a crank 1 of an embodiment of the apparatus 11 of the invention shown in FIG. 2. The apparatus 11 comprises generally a fluid chamber 12 mounted in a cradle frame 21 with an outlet wall 15 containing a fluid outlet 14 and an inlet wall 13 opposite to the outlet wall 15 containing a fluid inlet 16. Connected to the fluid inlet 16 is a downwardly dependent nozzle 17 which contains a resilient seal.

The apparatus further comprises a first L-shaped frame part 2 and a second L-shaped frame part 3. The parallel and spaced apart frame parts 2 and 3 are fixed to the inlet wall 13 by fasteners 5. The frame part 3 includes at its upper end a notch 31. The crank 1 comprises an elongate substantially U-shaped crankshaft 7 which extends laterally at one end into an extension 8 and at an opposite end into an extension 9. A base 7a of the crankshaft 7 is cylindrical. The extensions 8 and 9 are pivotally located in apertures 4a and 4b in the lower portion of the frame parts 2 and 3 respectively. The extension 9 is integral with a crank handle 6. The crank handle 6 terminates in a restraining latch 10 in the form of a U-shaped foot. The crank handle 6 and crankshaft 7 are out of plane by about 45°.

In use, a bottle 30 is seated on the base 7a of the crankshaft 7. For this purpose, the bottle 30 is generally provided with an elongate crescent-shaped groove in its base to engage the crankshaft 7 whereby to withstand any tendency to be dislodged. From the at-rest configuration shown in FIG. 1, the bottle resting on the crankshaft 7 is dismountable. By pivoting the crank handle 6 upwardly, the user exerts an eccentric rotary motion on the crankshaft 7 which progressively urges the bottle 30 upwardly against the resilient seal in the nozzle 17 towards and then beyond the retained position shown in FIG. 2. At the extreme position, the restraining latch 10 is manipulated into a configuration for latching and the crank handle 6 is released. The resilient seal relaxes and the restraining latch 10 latches the notch 31 to restrain the bottle 30 in the retained position shown in FIG. 2. In the retained position, the bottle 30 and crank handle 6 are in juxtaposition to the wall and the bottle 30 is cradled by the crank 1 and frame parts 2 and 3, whilst being restrained in positive sealing engagement with the resilient seal of the nozzle 17.

1. An apparatus for dispensing fluid from a fluid container comprising: a fluid chamber with an outlet wall containing a fluid outlet and an inlet wall containing a fluid inlet; a nozzle extending from or connected to the inlet; a cradle fixed to the inlet wall for seating the fluid container, wherein the cradle is manipulable in a manner such as to move the fluid container to selected positions including one or more dismount positions in which the fluid container is dismountable and a retained position in which the fluid container is retained in sealed engagement with the nozzle.

2. An apparatus as claimed in claim 1, wherein the cradle is pivotal in a manner such as to move the fluid container to the selected positions.

3. An apparatus as claimed in claim 1, wherein the cradle is manipulable in a manner whereby to progressively urge the fluid container into sealed engagement with the nozzle.

4. An apparatus as claimed in claim 1, wherein the cradle is restrainable when the fluid container is at the retained position.

5. An apparatus as claimed in claim 4, wherein the cradle is restrained by a restraining fastener when the fluid container is at the retained position.

6. An apparatus as claimed in claim 5, wherein the restraining fastener comprises a restraining latch selectively latchable with a restraining notch.

7. An apparatus as claimed in claim 1, wherein the fluid container in the retained position is retained in juxtaposition to the inlet wall.

8. An apparatus as claimed in claim 1, wherein the fluid container is assisted to be seated on the cradle by selectively engageable male and female portions.

9. An apparatus as claimed in claim 1, further comprising: a frame rigidly fixed to the inlet wall; and the cradle further comprises: a crank including an eccentric crankshaft for seating the fluid container, wherein the crank is pivotally mounted on the frame and is pivotal such that the crankshaft turns eccentrically to move the fluid container to the selected positions.

10. An apparatus as claimed in claim 9, wherein the crank further comprises a crank handle.

11. An apparatus as claimed in claim 9, wherein the eccentric crankshaft is substantially U-shaped.

12. An apparatus as claimed in claim 10, wherein the crank handle comprises a restraining latch selectively engageable with a restraining notch.

13. An apparatus as claimed in claim 11, wherein the substantially U-shaped crankshaft is preferably non-coplanar with the crank handle.

14. An apparatus as claimed in claim 13, wherein the crankshaft is out of the plane of the crank handle by an angle in the range of 35° to 65°.

15. An apparatus as claimed in claim 10, wherein when the fluid container is at the retained position the crank handle is in juxtaposition to the inlet wall.

16. An apparatus as claimed in claim 9, wherein the frame comprises a pair of substantially parallel, spaced apart elongate frame parts.

17. An apparatus as claimed in claim 16, wherein the frame parts are substantially L-shaped.

18. An apparatus as claimed in claim 1, wherein the nozzle is downwardly dependent.

19. An apparatus as claimed in claim 1, wherein the fluid container is a bottle.

20. An apparatus as claimed in claim 1, wherein the fluid container contains a liquid.

21. An apparatus as claimed in claim 20, wherein the liquid is an insecticide, biocide, disinfectant or deodoriser.

22. An apparatus as claimed in claim 20, wherein the apparatus is operable to dispense the liquid in the form of an ultra low volume spray.
